(19) United States
(12) Patent Application Publication
(10) Pub. No.: US 2025/0168282 A1
(43) Pub. Date: May 22, 2025

(54) IMAGE FORMING APPARATUS AND COLOR MEASUREMENT CONTROL METHOD

(71) Applicant: Konica Minolta, Inc., Tokyo (JP)

(72) Inventor: Satoru SHIRASAKA, Tokyo (JP)

(21) Appl. No.: 18/939,110

(22) Filed: Nov. 6, 2024

(30) Foreign Application Priority Data
Nov. 20, 2023 (JP) 2023-196400

(51) Int. Cl. H04N 1/00

(52) U.S. Cl. CPC H04N 1/00023; H04N 1/00045; H04N 1/00236; H04N 1/00246

(57) ABSTRACT

Disclosed is an image forming apparatus including: a colorimeter; a reader that reads an image formed on a recording medium; and a hardware processor that determines, in accordance with an operation state of the image forming apparatus or a type of a color measurement execution instruction, whether to execute color measurement by the colorimeter or to execute color measurement using the reader.

### BACKGROUND OF THE INVENTION

### Technical Field

The present invention relates to an image forming apparatus and a method of controlling color measurement.

### Description of Related Art

Conventionally, as a color measurement method, there are a color measurement method by a colorimeter and a color measurement method using a scanner. In a color measurement method using a colorimeter, for example, as described in Japanese Unexamined Patent Publication No. 2022-116556, a colorimeter connected in-line to an image forming apparatus slides a printed measurement chart (measurement sheet) in the cross direction (CD) to measure the colors of patches on the measurement sheet. On the other hand, color measurement using a scanner creates a color conversion table for converting scanner RGB (Red, Green, and Blue) values of the scanner arranged in the image forming apparatus into the Lab color space of the colorimeter. Next, the printed measurement chart (measurement sheet) is scanned, and the color value is measured (estimated) from the scanned image of the measurement sheet using the color conversion table.

Japanese Unexamined Patent Publication No. 2022-116556 Patent Document 1 describes that a sensor controller controls a colorimetric sensor to measure the density of a patch formed on a printed sheet for a page for which a colorimetric sensor measurement instruction has been received, and acquires colorimetric data (colorimetric result).

### SUMMARY OF THE INVENTION

As described above, conventionally, a color measurement method using a colorimeter, for example, the color measurement method described in Japanese Unexamined Patent Publication No. 2022-116556 directly measures the color value of a measurement sheet, and thus has high color measurement accuracy. However, the color measurement by the colorimeter requires a long color measurement time because the color measurement is performed by sliding the patches on the measurement sheet row by row. On the other hand, in the color measurement using a scanner, a colorimetric value is estimated by arithmetic processing of a computing machine using a scanned image of a measurement sheet and a color conversion table, so that the color measurement can be performed in a short time. However, the color measurement using the scanner has lower color measurement accuracy than the color measurement by the colorimeter. Therefore, a technique is desirable in which color measurement by a colorimeter and color measurement using a scanner are automatically switched in response to a request for color measurement accuracy.

The present invention has been made in consideration of the above-described situation, and an object of the present invention is to provide an image forming apparatus that reduces color measurement time.

According to an aspect of the present invention, an image forming apparatus reflecting one aspect of the present invention is an image forming apparatus including:
a colorimeter;
a reader that reads an image formed on a recording medium; and
a hardware processor that determines, in accordance with an operation state of the image forming apparatus or a type of a color measurement execution instruction, whether to execute color measurement by the colorimeter or to execute color measurement using the reader.

According to an aspect of the present invention, a color measurement control method reflecting one aspect of the present invention is a color measurement control method in an image forming apparatus including a colorimeter and a reader that reads an image formed on a recording medium, the method including
determining, according to an operation state of the image forming apparatus or a type of a color measurement execution instruction, whether to execute color measurement by the colorimeter or to execute color measurement using the reader.

### BRIEF DESCRIPTION OF THE DRAWINGS

The advantages and features provided by one or more embodiments of the invention will become more fully understood from the detailed description given hereinafter and the appended drawings which are given by way of illustration only, and thus are not intended as a definition of the limits of the present invention, and wherein:

FIG. 1 is a diagram illustrating a schematic configuration of an image forming apparatus according to an embodiment of the present invention;

FIG. 2 is a block diagram illustrating an example of a hardware configuration of an image forming apparatus according to an embodiment of the present invention;

FIG. 3 is a flowchart illustrating a procedure of first color measurement control processing in the image forming apparatus according to an embodiment of the present invention; and

FIG. 4 is a flowchart which shows the sequence of a second color measurement control process in the image forming apparatus according to one embodiment of the present invention.

### DETAILED DESCRIPTION

Hereinafter, one or more embodiments of the present invention will be described with reference to the drawings. However, the scope of the invention is not limited to the disclosed embodiments. In the present specification and drawings, constituent elements having substantially the same function or configuration are denoted by the same reference numerals, and redundant description is omitted.

### One Embodiment

### [Schematic Configuration of Image Forming Apparatus]

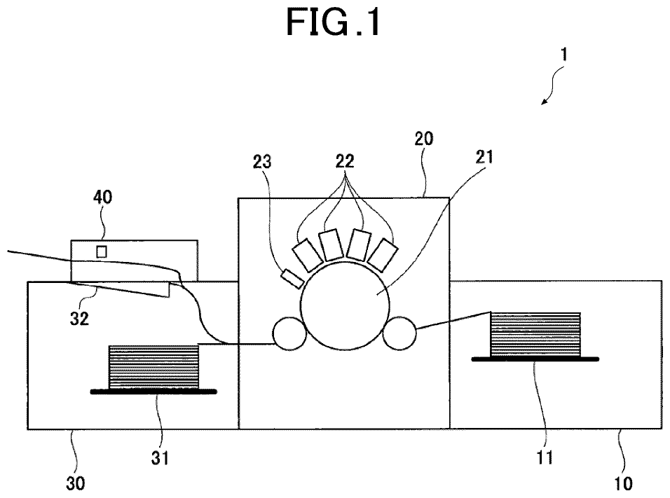

First, a schematic configuration of an image forming apparatus 1 according to an embodiment of the present invention will be described. FIG. 1 is a diagram illustrating a schematic configuration of image forming apparatus 1 according to the present embodiment. As illustrated in FIG. 1, the image forming apparatus 1 includes a sheet feed device 10, a printer 20, a sheet ejection device 30, and a colorimeter 40. The sheet feed device 10, the printer 20, and the sheet ejection device 30 are connected and arranged in this order from the upstream side to the downstream side in the conveyance direction of the recording medium. The colorimeter 40 is disposed so as to be connected to the sheet ejection device 30.

The sheet feed device 10 is an example of a recording medium supply device, includes a container (sheet feed tray) that stores recording media, and supplies the recording media to the printer 20. Note that in the present embodiment, printing sheet, cell, film, fabric, or the like can be used as the recording medium on which the image is formed. In addition, supplying a recording medium to the printer 20 is referred to as “sheet feeding”.

The printer 20 is, for example, a one pass UV inkjet printer, and as illustrated in FIG. 1, includes a main cylinder 21, a plurality of head units 22, and a scanner 23. The printer 20 is not limited to the one pass UV inkjet printer, and may be, for example, an image forming apparatus that forms an image on a recording medium by an electrophotographic method other than the one pass UV inkjet printer.

The main cylinder 21 is formed of a cylindrical member, and rotates counterclockwise in the drawing by a drive motor (not illustrated). The main cylinder 21 holds recording media along a cylindrical outer peripheral surface, and conveys the recording media in accordance with the rotation thereof. The conveyance surface of the main cylinder 21 faces the plurality of head units 22 and the scanner 23, and the head units 22 perform image formation-related processing on recording media conveyed in the main cylinder 21.

The plurality of head units 22 form an image by ejecting ink droplets at appropriate timings onto the recording surface of the recording media moving in accordance with the rotation of the main cylinder 21 and causing the ink droplets to land on the recording target surface of the recording media. The plurality of head units 22 may include, for example, four head units 22 that respectively eject four colors of ink. In this case, the four head units 22 are configured by, for example, head units that respectively eject Y (yellow), M (magenta), C (cyan), and K (black) inks.

The scanner 23 is an example of a reading device (reader) including an image sensor and the like, and reads an image formed on a recording medium, for example, an image of a test sheet for color measurement on which a plurality of patches are formed. Note that FIG. 1 illustrates an example in which the scanner 23 is configured inside the printer 20, but the scanner 23 may be configured outside the printer 20.

The sheet ejection device 30 includes a sheet ejection tray 31 for storing a recording medium on which an image is formed and which is ejected from the printer 20, and a sub-tray 32 for supplying a test sheet for color measurement to the colorimeter 40.

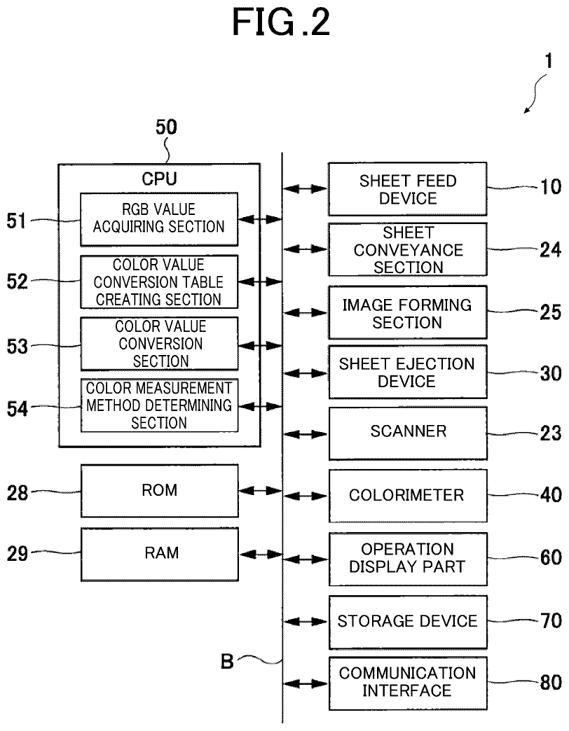

The colorimeter 40 is an automatic sheet feed type colorimeter, is formed with, for example, a spectral colorimeter capable of measuring color and gloss at the same time, and measures pixel values (color values) in the Lab color space of a test sheet for color measurement supplied by the sub tray 32. The colorimeter 40 also outputs the measured color value of the test sheet to a below-described central processing unit (CPU) 50 (see FIG. 2) of the image forming apparatus 1. In the present embodiment, when a color measurement method determining section 54 described later determines to perform color measurement by the colorimeter, the colorimeter 40 performs color measurement on the fed test sheet for color measurement. Note that the colorimeter 40 is not limited to the automatic sheet feed type, but may be a manual sheet feed type.

### [Hardware Configuration Example of Image Forming Apparatus]

Next, the hardware configuration of the image forming apparatus 1 will be described. FIG. 2 is a block diagram illustrating an example of a hardware configuration of the image forming apparatus 1 according to the present embodiment. As illustrated in FIG. 2, the image forming apparatus 1 further includes a sheet conveyance section 24, an image forming section 25, a CPU50 (hardware processor), a read only memory (ROM) 28, and a random access memory (RAM) 29, in addition to the constituent elements described in FIG. 1. The image forming apparatus 1 further includes an operation display part 60, a storage device 70, and a communication interface (IF) 80. The constituent elements described in FIG. 1, the sheet conveyance section 24, the image forming section 25, CPU50, ROM28, RAM29, the operation display part 60, the storage device 70, and the communication IF80 are connected to one another via a bus B so as to be able to perform information data transmission and reception with one another.

The sheet conveyance section 24 conveys, with a plurality of rollers, the recording medium fed from the sheet feed device 10 to the sheet ejection device 30.

The image forming section 25 includes the main cylinder 21 illustrated in FIG. 1, a plurality of head units 22, an irradiator, a transfer section, a fixing section, and the like (not illustrated), and forms an image on a recording medium by operation of the respective sections described above.

The CPU50 controls the operation of each constituent part of the image forming apparatus 1. The CPU50 performs, for example, control of an image forming process of the image forming section 25 based on a print instruction of a user performed via the operation display part 60, control of a sheet supply process by the sheet feed device 10, and the like. Furthermore, for example, the CPU50 performs first color measurement control processing and second color measurement control processing, which will be described later, on the basis of a color measurement execution instruction given by the user via the operation display part 60. Note that a graphics processing unit (GPU) may be used instead of CPU50, or CPU50 and a GPU may be used in combination.

As illustrated in FIG. 2, the CPU50 includes an RGB value acquiring section 51, a color value conversion table creating section 52, a color value conversion section 53, and a color measurement method determining section 54. Note that in FIG. 2, only the constituent sections of CPU 50 involved in the first color measurement control process and the second color measurement control process described later is illustrated, and illustration and description of the constituent sections involved in the other processes are omitted.

The RGB value acquiring section 51 acquires, from the read image of the test sheet for creation of the color value conversion table read by the scanner 23, the RGB values of each patch included in the test sheet for creation, and outputs the RGB values to the color value conversion table creating section 52. The RGB value acquiring section 51 acquires the RGB values of each patch included in the test sheet for color measurement from the read image of the test sheet for color measurement read by the scanner 23, and outputs the RGB values to the color value conversion section 53.

The color value conversion table creating section 52 creates a color value conversion table using the colorimetric values of the patches included in the test sheet for creating the color value conversion table, which are measured by the colorimeter 40, and the RGB values of the patches acquired by the RGB value acquiring section 51. Note that the color value conversion table is a data table for converting the RGB values of the scanner 23 into pixel values in the Lab color space of the colorimeter 40.

The color value conversion section 53 converts the RGB values of each patch included in the read image of the test sheet for color measurement read by the scanner 23 into pixel values in the Lab color space, based on the color value conversion table. In the present embodiment, when the color measurement method determining section 54 determines to perform color measurement using the scanner 23, the color value conversion section 53 performs color value conversion on the read image of the test sheet for color measurement read by the scanner 23.

The color measurement method determining section 54 determines whether to execute color measurement by the colorimeter 40 or to execute color measurement using the scanner 23 in accordance with the operation state of the own apparatus (image forming apparatus 1) or the type of color measurement execution instruction. Here, the operation state includes an initial setup state, a activation state after a long-term stop, and a state in which there is component replacement that affects printing. Types of the color measurement execution instruction include regular color measurement, color measurement before and after execution of a print job, and color measurement during execution of a print job. Note that also in a case where the operation state of the image forming apparatus 1 is another state (a state other than the above-described operation states) that affects print quality, it is necessary to perform color measurement with the colorimeter having high color measurement accuracy.

The color measurement method determining section 54 determines to execute color measurement by the colorimeter 40 when the own apparatus receives the first color measurement execution instruction after activation and the operation state of the own apparatus is any of an initial setup state, an activation state after long-time stop, and a state in which there is component replacement that affects printing. This determination is made because when the operation state of the image forming apparatus 1 is any of the various operation states described above, there is a possibility that the print quality will be affected, and therefore it is necessary to perform color measurement with a colorimeter having high color measurement accuracy. In addition, the color measurement method determining section 54 determines to perform color measurement using the scanner 23 in a case where the operation state of the own apparatus is a state other than the initial setup state, the activation state after long-time stop, and the state in which there is component replacement that affects printing.

The color measurement method determining section 54 determines to execute color measurement using the scanner 23 when a color measurement execution instruction other than the above-described first color measurement execution instruction is received and the type of the color measurement execution instruction is one of regular color measurement, color measurement before and after the execution of a print job, and color measurement during the execution of a print job. This determination is made because the steady measurement, the color measurement before and after the execution of the print job, and the color measurement during the execution of the print job have less stringent requirements for the color measurement accuracy. If the type of the color measurement execution instruction is other than the regular color measurement, the color measurement before and after execution of the print job, and the color measurement during execution of the print job, the color measurement method determining section 54 determines to execute the color measurement by the colorimeter 40. Here, the case other than the regular color measurement, the color measurement before and after the execution of the print job, and the color measurement during the execution of the print job is, for example, a case where the user designates the color measurement by the colorimeter in the manual displayed on the operation display part 60.

Reference numeral ROM28 denotes a storage medium, such as a nonvolatile memory, which stores programs, data, and the like to be executed and referred to by CPU50.

Reference numeral RAM29 denotes a storage medium such as a volatile memory, for example, which temporarily stores information (data) necessary for each process performed by CPU50.

The operation display part 60 includes a display part formed of a display device or the like such as a liquid crystal display (LCD) or an organic electro-luminescence (EL) display, and an operation part formed of a touch sensor or the like. The display part and the operation part are integrally formed as a touch screen, for example. The operation display part 60 generates an operation signal indicating details of a user operation input to the operation part, and supplies the operation signal to the operation part CPU50. The operation display part 60 also displays details of a user operation, setting information, and the like on the display part on the basis of a display signal supplied from the display part CPU50. Note that the operation part can be formed of a mouse, a tablet, or the like to be formed separately from the display part.

The storage device 70 is configured by a computer-readable non-transitory recording medium that stores a program executed by the processor CPU50, and is configured by a storage device such as a hard disk drive (HDD). The storage device 70 stores a program for the controller CPU50 to control each section, an operating system (OS), a program such as a controller, and data. Note that some of the programs and data stored in the storage device 70 may be stored in the storage device ROM28. Furthermore, the computer-readable non-transitory recording medium that stores the program to be executed by the information processing apparatus CPU50 is not limited to the HDD, but may be, for example, a recording medium such as a solid state drive (SSD), a compact disc (CD)-ROM, a digital versatile disc (DVD)-ROM, or the like.

The communication IF80 includes a network interface card (NIC) and a modem, establishes connection with a post-processing apparatus (not illustrated), a personal computer (PC) terminal (not illustrated), and the like, and transmits and receives various types of data.

### [Procedure of First Color Measurement Control Processing]

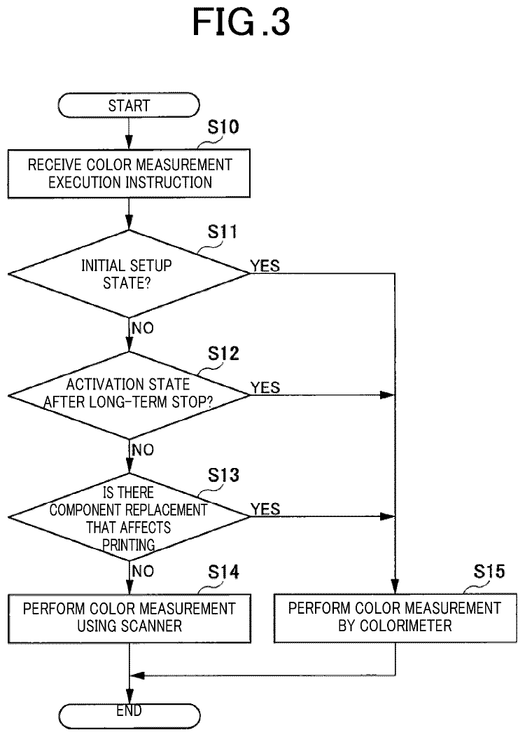

Next, the first color measurement control processing in the image forming apparatus 1 will be described. The first color measurement control process is a process executed by the image forming apparatus 1 when the image forming apparatus 1 receives the first color measurement execution instruction after activation. In the first color measurement control process, the image forming apparatus 1 performs color measurement control in accordance with the operation state of the image forming apparatus 1. FIG. 3 is a flowchart illustrating a procedure of first color measurement control processing in the image forming apparatus 1 according to the present embodiment. The processing described below starts when a user gives a color measurement execution instruction for the first time via the operation display part 60 after the image forming apparatus 1 is activated.

First, the CPU50 of the image forming apparatus 1 receives a color measurement execution instruction from the operation display part 60 (S10).

Next, the CPU50 color measurement method determining section 54 determines whether or not the operation state of the image forming apparatus 1 is the initial setup state (S11).

If the color measurement method determining section 54 determines that the operation state of the image forming apparatus 1 is the initial setup state (YES in S11), the color measurement method determining section 54 performs the below-described S15 process.

On the other hand, when determining that the operation state of the image forming apparatus 1 is not the initial setup state (NO in S11), the color measurement method determining section 54 performs the processing in S12. In the processing of the S12, the color measurement method determining section 54 determines whether or not the operation state of the image forming apparatus 1 is the activation state after long-term stop.

When determining that the operation state of the image forming apparatus 1 is the activation state after long-term stop (YES in S12), the color measurement method determining section 54 performs S15 processing to be described later.

On the other hand, when determining that the operation state of the image forming apparatus 1 is not the activation state after long-term stop (NO in S12), the color measurement method determining section 54 determines whether or not the image forming apparatus 1 is in a state where there is component replacement that affects printing (S13).

When determining that there is no component replacement that affects printing (NO in S13), the color measurement method determining section 54 determines to perform color measurement using the scanner 23 (S14). In addition, in S14, the color value conversion section 53 performs color measurement by performing color value conversion on the basis of the read image of the test sheet for color measurement read by the scanner 23 and the color value conversion table created by the color value conversion table creating section 52.

On the other hand, when the color measurement method determining section 54 determines that there is a component replacement that affects printing (YES in S13), the color measurement method determining section 54 determines to perform color measurement by the colorimeter 40 (S15). In S15, CPU50 outputs a color measurement instruction to the colorimeter 40. Next, the colorimeter 40 performs color measurement on the test sheet for color measurement supplied by the sub tray 32. After the process of S14 or S15, the first color measurement control process ends.

### [Second Color Measurement Control Processing]

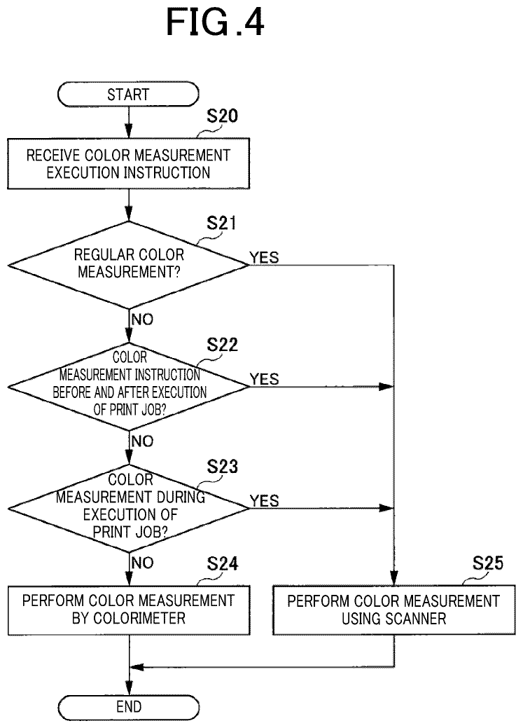

Next, the second color measurement control processing in the image forming apparatus 1 will be described. The second color measurement control processing is processing that the image forming apparatus 1 executes in a case where the image forming apparatus 1 receives a color measurement execution instruction other than the first color measurement execution instruction after activation. In the second color measurement control process, the image forming apparatus 1 performs color measurement control in accordance with the type of color measurement execution instruction. FIG. 4 is a flowchart illustrating a procedure of second color measurement control processing in the image forming apparatus 1 according to the present embodiment. The processing described below starts when a user provides a color measurement execution instruction via the operation display part 60.

First, the CPU50 of the image forming apparatus 1 receives a color measurement execution instruction from the operation display part 60 (S20).

Next, the color measurement method determining section 54 of CPU50 determines whether or not the type of the color measurement execution instruction is the regular color measurement (S21).

When determining that the type of the color measurement execution instruction is the regular color measurement (YES in S21), the color measurement method determining section 54 performs processing in S25 which will be described later.

On the other hand, when determining that the type of the color measurement execution instruction is not the regular color measurement (NO in S21), the color measurement method determining section 54 determines whether or not the color measurement execution instruction is a color measurement instruction before and after execution of the print job (S22). Note that in order to ensure print quality in the case of large-volume printing, test charts for color measurement may be added to the start, middle, and end of a print job, and color measurement may be performed before, after, and during execution of the print job.

When determining that the type of the color measurement execution instruction is color measurement before and after execution of the print job (YES in S22), the color measurement method determining section 54 performs S25 processing to be described later.

On the other hand, when determining that the type of the color measurement execution instruction is not the color measurement before and after the execution of the print job (NO in S22), the color measurement method determining section 54 determines whether or not the type of the color measurement execution instruction is the color measurement during the execution of the print job (S23).

When it is determined that the type of the color measurement execution instruction is not the color measurement during the execution of the print job (NO in S23), the color measurement method determining section 54 determines to perform the color measurement by the colorimeter 40 (S24). Furthermore, in this processing, the CPU50 outputs a color measurement instruction to the colorimeter 40. Next, the colorimeter 40 performs color measurement on the test sheet supplied by the sub tray 32.

On the other hand, in a case where it is determined that the type of the color measurement execution instruction is the color measurement during the execution of the print job (YES in S23), the color measurement method determining section 54 determines to perform the color measurement using the scanner 23 (S25). In addition, in this processing, the first color value conversion section 53 of the CPU 50 performs color measurement by performing color value conversion on the basis of the read image of the test sheet for color measurement read by the scanner 23 and the color value conversion table created by the color value conversion table creating section 52. After the process of S24 or S25, the second color measurement control process ends.

### EFFECT

As described above, upon receiving the instruction to perform color measurement for the first time after activation, the image forming apparatus 1 according to the present embodiment performs the first color measurement control processing of automatically switching between color measurement by the colorimeter and color measurement using the scanner according to the operation state of the own apparatus. In the first color measurement control process, when the operation state of the image forming apparatus 1 is any one of the initial setup state, the activation state after long-term stop, and the state in which there is component replacement that affects printing (when the requested color measurement accuracy is high), the image forming apparatus 1 performs color measurement by the colorimeter 40. Furthermore, the image forming apparatus 1 performs color measurement using the scanner 23 when the operation state of the apparatus is other than the initial setup state, the activation state after long-term stop, and the state in which there is component replacement that affects printing (when the required color measurement accuracy is not high).

In addition, in a case where the image forming apparatus 1 according to the present embodiment receives the color measurement execution instruction after the first color measurement execution instruction after activation, the image forming apparatus 1 performs the second color measurement control process of automatically switching between color measurement by the colorimeter and color measurement using the scanner according to the type of the color measurement execution instruction. In the second color measurement control process, the image forming apparatus 1 executes color measurement using the scanner 23 in a case where the type of the color measurement execution instruction is any one of steady measurement, color measurement before and after execution of a print job, and color measurement during execution of a print job (in a case where the requested color measurement accuracy is not high). When the type of the color measurement execution instruction is other than the regular color measurement, the color measurement before and after the execution of the print job, and the color measurement during the execution of the print job (when the requested color measurement accuracy is high), the image forming apparatus 1 executes the color measurement by the colorimeter. Therefore, according to the image forming apparatus 1 of the present embodiment, it is possible to shorten the color measurement time by automatically switching between color measurement using a colorimeter and color measurement using a scanner in response to a request for color measurement accuracy.

Further, according to the present embodiment, it is possible to provide an image forming apparatus that shortens the color measurement time.

Note that the present invention is not limited to the above-described embodiment, and it is needless to say that other various application examples and modification examples can be adopted without departing from the spirit and scope of the present invention described in the claims.

For example, in the above-described embodiment, the configuration of the image forming apparatus has been described in detail and specifically in order to describe the present invention in an easy-to-understand manner, and the present invention is not necessarily limited to one including all of the described configurations. Furthermore, part of the configuration of the embodiment described here can be replaced with the configuration of another embodiment, and furthermore, the configuration of another embodiment can be added to the configuration of one embodiment. Furthermore, it is also possible to add, delete, or replace another configuration with respect to a part of the configuration of the embodiment.

In addition, control lines and information lines that are considered to be necessary for description are illustrated, and all of the control lines and information lines on a product are not necessarily illustrated. Actually, it may be considered that almost all of the components are connected to each other.

Although embodiments of the present invention have been described and illustrated in detail, the disclosed embodiments are made for purposes of illustration and example only and not limitation. The scope of the present invention should be interpreted by terms of the appended claims.

The entire disclosure of Japanese Patent Application No. 2023-196400, filed on Nov. 20, 2023, including description, claims, drawings and abstract is incorporated herein by reference.

What is claimed is:

1. An image forming apparatus comprising:
a colorimeter;
a reader that reads an image formed on a recording medium; and
a hardware processor that determines, in accordance with an operation state of the image forming apparatus or a type of a color measurement execution instruction, whether to execute color measurement by the colorimeter or to execute color measurement using the reader.

2. The image forming apparatus according to claim 1, wherein the operation state includes an initial setup state, an activation state after long-term stop, and a state in which there is component replacement that affects printing.

3. The image forming apparatus according to claim 1, wherein the type of the color measurement execution instruction includes regular color measurement, color measurement before and after execution of a print job, and color measurement during execution of a print job.

4. The image forming apparatus according to claim 2, wherein, in response to reception of a first color measurement execution instruction after activation of the image forming apparatus, the hardware processor
determines to execute the color measurement by the colorimeter when the operation state is any of the initial setup state, the activation state after the long-term stop, and the state in which there is the component replacement that affects the printing, and
determines to execute the color measurement using the reader when the operation state is a state other than the initial setup state, the activation state after the long-term stop, and the state in which there is the component replacement that affects the printing.

5. The image forming apparatus according to claim 3, wherein, in response to reception of a color measurement execution instruction other than a first color measurement execution instruction after activation of the image forming apparatus, the hardware processor
determines to execute the color measurement using the reader when the type of the color measurement execution instruction is any of the regular color measurement, the color measurement before and after the execution of the print job, and the color measurement during the execution of the print job, and
determines to execute the color measurement by the colorimeter when the type of the color measurement execution instruction is other than the regular color measurement, the color measurement before and after the execution of the print job, and the color measurement during the execution of the print job.

6. The image forming apparatus according to claim 1, wherein the hardware processor
acquires, from a read image of a test sheet for creation of a color value conversion table read by the reader, RGB values of each patch included in the test sheet for the creation of the color value conversion table, acquires, from a read image of a test sheet for color measurement read by the reader, RGB values of each patch included in the test sheet for the color measurement,
creates a color value conversion table for converting the RGB values into a pixel value in a Lab color space of the colorimeter by using a colorimetric value of each patch included in the test sheet for the creation of the color value conversion table measured by the colorimeter and the acquired RGB values of each patch, and
converts the RGB values of each patch included in the read image of the test sheet for the color measurement read by the reader into a pixel value in the Lab color space, based on the color value conversion table.

7. The image forming apparatus according to claim 1, wherein, when the hardware processor determines to execute the color measurement by the colorimeter, the colorimeter executes color measurement on a fed test sheet for color measurement.

8. The image forming apparatus according to claim 6, wherein, when the hardware processor determines to execute the color measurement using the reader, the hardware processor executes color value conversion on the read image of the test sheet for the color measurement read by the reader.

9. A color measurement control method in an image forming apparatus including a colorimeter and a reader that reads an image formed on a recording medium, the method comprising
determining, according to an operation state of the image forming apparatus or a type of a color measurement execution instruction, whether to execute color measurement by the colorimeter or to execute color measurement using the reader.
